(19) United States
(12) Patent Application Publication
(10) Pub. No.: US 2014/0358300 A1
(43) Pub. Date: Dec. 4, 2014

(54) Portable Control System for Cylinder Cabinet

(71) Applicant: MACRONIX INTERNATIONAL CO., LTD., Hsinchu City (TW)

(72) Inventor: Yongchi Yang, Zhunan Township (TW)

(73) Assignee: MACRONIX INTERNATIONAL CO., LTD., Hsinchu City (TW)

(21) Appl. No.: 14/185,862

(22) Filed: Feb. 20, 2014

Related U.S. Application Data
(60) Provisional application No. 61/786,619, filed on Mar. 15, 2013.

(51) Int. Cl. G05D 7/06

(52) U.S. Cl. CPC G05D 7/0617
USPC 700/282

(57) ABSTRACT

An apparatus for controlling a gas supplying system comprises a monitor system configured to monitor a parameter related to ensure safety delivery of gas from a cylinder to a semiconductor manufacturing process. The cylinder is placed in a gas cabinet. The apparatus further comprises a control circuit. The control circuit is configured to receive a signal indicative of the monitored parameter and provide a control signal to control operations of the gas supplying system. The apparatus is portable and independent of the gas cabinet.

### CROSS-REFERENCE TO RELATED APPLICATION

This application claims priority of provisional Application No. 61/786,619, filed on Mar. 15, 2013, the content of which are incorporated herein by reference in its entirety.

### TECHNOLOGICAL FIELD

The present invention generally relates to an apparatus for controlling a cylinder cabinet. More specifically, the invention relates to a portable control system for controlling a cylinder cabinet.

### BACKGROUND

In the semiconductor manufacturing industry, cylinders are used to supply high purity process gases such as SiH₄, PH₃, and NF₃ used in production, such as for carrying out various semiconductor manufacturing processes. Examples of such processes include diffusion, chemical vapor deposition (CVD), etching, sputtering, and ion implantation. The process gas may be highly toxic, flammable, or corrosive. Hence, safely and tightly controlling the process gas may pose many challenges. Cylinders are typically housed within gas cabinets to facilitate the change of cylinders. The equipment and methods of controlling the functions of the gas cabinets supplying the process gas are therefore of great significance.

The gas cabinet typically includes a gas panel with a plurality of valves and a control circuit that controls operations of the valves, etc. in a configuration allowing cylinder changes and/or component replacement in a safe manner. The gas panel is usually mounted above the gas cabinet and welded to the gas cabinet. When the gas panel breaks down, the supply may be disconnected. The process gas supply may similarly be disrupted by cleaning, repair, maintenance needs. Disconnection and disruption the process gas supply may significantly negatively influence production in the semiconductor industry. There is a need in the art for improved methods and apparatus to reduce production down-time of gas cabinets supplying process gases for semiconductor manufacturing.

### BRIEF SUMMARY OF EXEMPLARY EMBODIMENTS OF THE INVENTION

The present invention provides methods and processes to reduce production down-time of gas cabinet supplying process gases. For example, embodiments of the present invention provide a method and apparatus that controls a flow of gas to reduce by-products thereby substantially reducing production downtime needed for cleaning and/or replacing of lines, valves, and vacuum pumps that may increase cost of maintenance.

According to one exemplary embodiment of the present invention, an apparatus for controlling a gas supplying system comprises a monitor system configured to monitor a parameter related to ensure safety delivery of gas from a cylinder to a semiconductor manufacturing process. The cylinder is placed in a gas cabinet. The apparatus further comprises a control circuit. The control circuit is configured to receive a signal indicative of the monitored parameter and provide a control signal to control operations of the gas supplying system. The apparatus is portable and independent of the gas cabinet.

According to one exemplary embodiment of the present invention a method of controlling a gas supplying system with a portable control system comprises a monitor system and a control circuit. The method comprises monitoring, on the monitor system, the portable control system a parameter related to ensure safety delivery of gas from a cylinder to a semiconductor manufacturing process. The cylinder is placed in a gas cabinet separated from the portable control system. The method further comprises controlling operations of the gas supply system by control signal generated by the control circuit of the portable control system in response to signals received by the control circuit indicative of parameters monitored by the control circuit.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates a diagram of a gas supplying system in accordance with example embodiments of the invention; and

FIG. 2 shows a schematic block diagram of a circuitry in accordance with example embodiments of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise. Like numbers refer to like elements throughout.

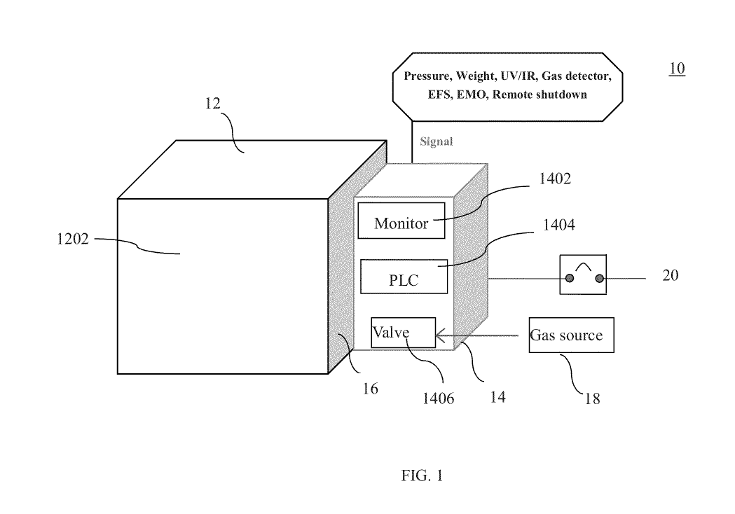

FIG. 1 illustrates a diagram of a gas supplying system 10 in accordance with an embodiment of the invention. Gases that are used for semiconductor manufacturing processes may be stored and dispensed from some type of enclosure. In this embodiment, process gases and/or inert purge gas may be stored in a gas cabinet 12. The gas cabinet 12 may carry one or more process cylinders (not shown) and/or a purge cylinder (not shown). The gas supplying system 10 may further comprise a control system 14 for controlling the gas cabinet 12. Various parameters may be monitored during operations to insure efficient and safe delivery of gas from cylinders to the semiconductor manufacturing process. The control system 14 may comprise a monitor system 1402 to monitor these parameters.

Gas pressure is one of the monitored parameters. Pressure gauges may be used in supplying system to monitor that pressures are being maintained at a safe level. The gas supplying system 10 may comprise a pressure regulator to reduce the pressure of the gas flowing through the pressure regulator, therefore maintaining a constant pressure downstream of the pressure regulator. The gas supplying system 10 may further comprise one or more pressure detectors to detect gas pressures and provide pressure signals. The pressure regulator and pressure detector may be installed in the gas cabinet 12 or other locations. The monitor system 1402 may monitor gas pressure regularly to allow sufficient time for cylinder changes before the gas is completely gone. The monitoring system 1402 may also monitor cylinder pressure when the gases are liquefied in the cylinder.

The cylinder pressure may not be a sufficient indication of the remaining contents in a cylinder. In addition or alternatively, cylinder scale may be used to weight the remaining gases in cylinder to ensure that some positive pressure is left inside the cylinder to prevent atmosphere intrusion during cylinder exchange operations. Weight may also indicate an overfilled cylinder, an extremely dangerous situation. The cylinder scale may provide weight signals to indicate weight contents of a cylinder.

To deliver the gas required for the process, the monitoring system 1402 may also monitor gas that flows through a gas regulator. Gas flow may be measured by flow meters and may be restricted using flow restrictors, such as using an excess flow switch or a flow restrictor, in case the gas flow exceeds a limit The excess flow switch may be either mechanical or electromechanical and may have an excess flow sensor which may activate an excess flow valve, shutting off gas flow when a preset limit is exceeded.

The monitoring system 1402 may also monitor cylinder temperatures during operations. Some liquefied gases may require a large amount of heat to vaporize. But gases stored in cylinders may be dangerous when exposed to high temperatures. In such cases, the monitoring system 1402 may monitor temperature of the interior of the gas cabinet and/or the cylinder itself using a temperature monitoring system. Temperature monitoring systems may include, for example, a thermocouple or resistance temperature detector with heat detectors installed.

While heat may indicate that a fire is in progress, monitoring temperature may not be sufficient to ensure fire safety since not all fires can excite fire detectors. Hence the monitoring system 1402 may monitor the cylinder cabinet for smoke, ultraviolet or infrared radiation. Flame detectors may include, for example, optical flame detectors, such as using optical sensors to detect flames; ionization flame detectors such as using current flow in the flame to detect flame presence; and thermocouple flame detectors. An optical flame detector may comprise an ultraviolet flame detector, an infrared flame detector, and an ultraviolet/infrared (UV/IR) flame detector that reacts to both UV and IR flame radiation, dual wavelength infrared, and multi-spectrum flame actuated detector.

Another important operation in receiving the cylinder is to check the cylinder for leaks prior to storing or using the cylinder. The monitoring system 1402 may monitor for gas leaks inside the gas cabinet, in gas line, or in the surrounding area. A leak check may be performed using various monitoring devices that are available based on a number of different technologies. The monitoring devices may include solid state sensors, electrochemical sensors, and page type sensors that draw a sample from the sensing area to a remote location to react with chemicals on the tape. The monitoring system may monitor more parameters, such as exhaust flow, flow rate, etc. Each parameter is obtained using a detector, a sensor, or a monitoring system.

The control system 14 may further comprise a control circuit 1404 which may comprise a programmable logic controller. The control circuit 1404 may receive a signal that indicates a parameter monitored by detectors, sensors, monitoring systems mentioned above. For example, a gauge may be coupled to the control circuit 1404 that receives a gas signal indicative of gas pressure inside the gas cabinet or of the gas line. The control circuit 1404 may receive a temperature signal indicative of temperature inside the gas cabinet. The control circuit 1404 may receive a flame signal indicative of smoke or ultra violet or infrared radiation inside the cabinet. The control circuit 1404 may also receive a leak signal indicative of a leak inside the cabinet or in surrounding area. According to the received signals, the control circuit 1404 may provide control signals to control valve sequencing for various modes of control.

The functions mentioned above may be connected to an emergency shutoff system or plant alarm system. When an emergency occurs, the control system may determine that one of the monitored parameters is incorrect and provide a signal to the emergency shutoff system to shut down the supply system. For example, flow monitoring devices may be connected to the control system. When the flow deviates from the normal range, the control system may shut down the gas supplying system. For another example, flow switches may be used that will provide a signal to the control system if flow goes either too high or too low. If a leak occurred, the flow rate would probably rise, and any of these devices could signal the control system to shut off the flow of gas, helping to contain any hazard. The emergency shutoff system may also allow the operator to manually shut off the gas cabinet to disconnect the gas supplying system. The gas supplying system may exit an operation mode and enter an emergency mode.

The control system 14 may also control a purging process for cylinder exchange. The control system may comprise an electronically operated valve 1406, for example, a solenoid valve, configured to receive purge gas from a gas source 18 and supply the gas for example, to a pneumatic valve 1202 in the gas cabinet. The valve 1406 may be connectable to the gas cabinet by a gas line 16. The gas line 16 may be for example, a flexible connector or a stainless steel tube. For example, the gas line 16 may be a flexible metal pigtail connector.

The gas supplying system 10 may be coupled to a power supply unit 20 which may provide a power to the gas supplying system 10. The power supplying unit 20 may comprise a normal power system, an emergency power system and a standby power system. The power supplying unit 20 may help to reduce production down-time of gas cabinets supplying process gases for semiconductor manufacturing.

According to example embodiments of the present invention, the example control system is a portable system independent of the cylinder cabinet. The control system 14 may be connectable to any gas cabinet and operable with any gas cabinet. In this configuration, when the control system breaks down, another control system may be connected to the gas cabinet as a replacement and operate with the gas cabinet due to the portability of the control system. In this manner, without changing gas cabinet or cylinders, the supplying system keeps in operation mode with minimum period of suspension.

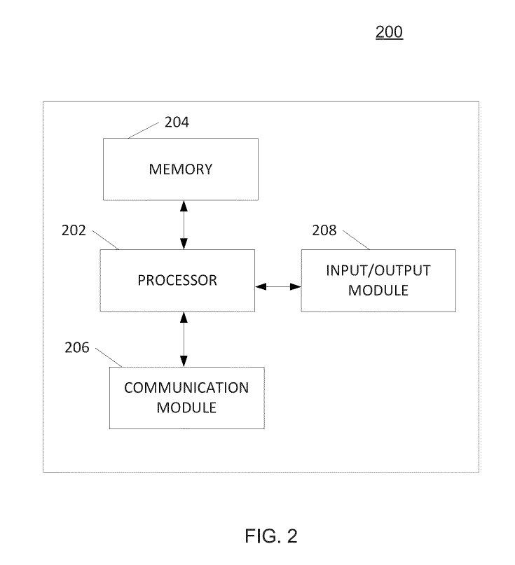

FIG. 2 shows a schematic block diagram of an exemplary embodiment of the control circuit 1404. As illustrated in FIG. 2, in accordance with some example embodiments, the control circuit may include various means, such as processor 202, memory 204, communications module 206, and/or input/output module 208. As referred to herein, “module” includes hardware, software and/or firmware configured to perform one or more particular functions. In this regard, the means of the control circuit as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 204) that is executable by a suitably configured processing device (e.g., processor 202), or some combination thereof.

Processor 202 may, for example, be embodied as various means including one or more microprocessors with accompanying digital signal processor(s), one or more processor(s) without an accompanying digital signal processor, one or more microcontroller, one or more coprocessors, one or more multi-core processors, one or more controllers, processing circuitry, one or more computers, various other processing elements including integrated circuits such as, for example, a PLC (program logic controller), an ASIC (application specific integrated circuit) or FPGA (field programmable gate array), or some combination thereof. Accordingly, although illustrated in FIG. 2 as a single processor, in some embodiments processor 202 comprises a plurality of processors. In an example embodiment, processor 202 is configured to execute instructions stored in memory 204 or otherwise accessible to processor 202. These instructions, when executed by processor 202, may cause valves to perform one or more of the functionalities.

Whether configured by hardware, firmware/software methods, or by a combination thereof, processor 202 may comprise an entity capable of performing operations according to embodiments of the present invention while configured accordingly. Thus, for example, when processor 202 is embodied as a PLC, ASIC, FPGA or the like, processor 202 may comprise specifically configured hardware for conducting one or more operations described herein. Alternatively, as another example, when processor 202 is embodied as an executor of instructions, such as may be stored in memory 204, the instructions may specifically configure processor 202 to perform one or more algorithms and operations.

Memory 204 may comprise, for example, volatile memory, non-volatile memory, or some combination thereof. Although illustrated in FIG. 2 as a single memory, memory 204 may comprise a plurality of memory components. The plurality of memory components may be embodied on a single computing device or distributed across a plurality of computing devices. In various embodiments, memory 204 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 204 may be configured to store information, data (including deal parameter data and/or analytics data), applications, instructions, or the like for enabling valves to carry out various functions in accordance with example embodiments of the present invention. For example, in at least some embodiments, memory 204 is configured to buffer input data for processing by processor 202. Additionally or alternatively, in at least some embodiments, memory 204 is configured to store program instructions for execution by processor 202. Memory 204 may store information in the form of static and/or dynamic information. This stored information may be stored and/or used by the processor 202 during the course of performing its functionalities.

Communications module 206 may be embodied as any device or means embodied in circuitry, hardware, a computer program product comprising computer readable program instructions stored on a computer readable medium (e.g., memory 204) and executed by a processing device (e.g., processor 202), or a combination thereof that is configured to receive and/or transmit data from/to another device, such as, for example, pressure detector, temperature detector, and/or the like. In some embodiments, communications module 206 (like other components discussed herein) can be at least partially embodied as or otherwise controlled by processor 202. In this regard, communications module 206 may be in communication with processor 202, such as via a bus. Communications module 206 may include, network interface card and/or supporting hardware and/or firmware/software for enabling communications with another computing device. Communications module 206 may be configured to receive and/or transmit any data to the processor 202 using any protocol that may be used for communications between computing devices. Communications module 206 may additionally or alternatively be in communication with the memory 204, and/or input/output module 208, such as via a bus.

Input/output module 208 may be in communication with processor 202 to receive signals from detectors, sensors (such as gas flow and radiation), actuators (such as valves and cylinders), switches (such as excess flow switch) and analog process variables (such as temperature and pressure) and to provide an audible, visual, mechanical, or other systems such as valves. The control circuit may include built-in input/output modules or external input/output modules.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for controlling a gas supplying system, comprising:
a monitor system configured to monitor a parameter related to ensure safety delivery of gas from a cylinder to a semiconductor manufacturing process, the cylinder placed in a gas cabinet; and
a control circuit configured to:
receive a signal indicative of the monitored parameter; and
provide a control signal to control operations of the gas supplying system,
wherein the apparatus is portable and independent of the gas cabinet.

2. The apparatus of claim 1 further comprising an electronically operated valve configured to receive gas from a gas source and supply the gas to a pneumatic valve installed in the gas cabinet, the electronically operated valve being connectable to the gas cabinet by a gas line.

3. The apparatus of claim 2, wherein the electronically operated valve comprises a solenoid valve.

4. The apparatus of claim 1, wherein the signal comprises a gas pressure signal provided by a pressure detector, the gas pressure signal indicative of a pressure inside the gas cabinet or surrounding area.

5. The apparatus of claim 1, wherein the signal comprises an exhaust pressure signal provided by an exhaust pressure detector, the pressure signal indicative of exhaust pressure of the cylinder.

6. The apparatus of claim 1, wherein the signal comprises a weight signal provided by a cylinder scale, the weight signal indicative of gas weight in the cylinder.

7. The apparatus of claim 1, wherein the signal comprises a flame signal provided by a flame detector, the flame signal indicative of a flame radiation inside the cylinder.

8. The apparatus of claim 1, wherein the signal comprises a gas flow signal provided by a gas detector, the gas flow signal indicative of gas flow rate inside the gas cabinet or gas line.

9. The apparatus of claim 1, wherein the signal comprises an emergency shutoff signal to indicate an emergency in the presence of an incorrect monitored parameter.

10. The apparatus of claim 1, wherein the signal comprises a leak signal provided by a leak detector, the leak signal indicative of a gas leak inside the gas cabinet or in the surrounding area.

11. The apparatus of claim 1, wherein the signal comprises a temperature signal indicative of temperature of the gas cabinet or the cylinder.

12. The apparatus of claim 1, wherein the apparatus is connectable to the gas cabinet by a gas line to transport process gas or purge gas.

13. A method of controlling a gas supplying system with a portable control system comprising a monitor system and a control circuit, the method comprising:
monitoring, on the monitor system, the portable control system, a parameter related to ensure safety delivery of gas from a cylinder to a semiconductor manufacturing process, the cylinder placed in a gas cabinet separated from the portable control system; and
controlling operations of the gas supply system by control signal generated by the control circuit of the portable control system in response to signals received by the control circuit indicative of parameters monitored by the control circuit.
